(19) United States
(12) Patent Application Publication
(10) Pub. No.: US 2016/0344864 A1
(43) Pub. Date: Nov. 24, 2016

(54) SYSTEMS AND METHODS FOR PROVIDING CONTEXT TO A FORWARDED CALL

(71) Applicant: Sabse Technologies, Inc., Mountain View, CA (US)

(72) Inventors: Sabeer Bhatia, Mountain Viiew, CA (US); Ravi Patel, Mountain View, CA (US); Dhruv Patel, Mountain View, CA (US)

(21) Appl. No.: 15/225,495

(22) Filed: Aug. 1, 2016

Related U.S. Application Data
(63) Continuation-in-part of application No. 14/498,338, filed on Sep. 26, 2014, now Pat. No. 9,407,763.

(51) Int. Cl. H04M 3/42; H04M 3/54

(52) U.S. Cl. CPC H04M 3/42042; H04M 3/54

(57) ABSTRACT

Systems and methods for providing context to a forwarded call include a private branch exchange (PBX) that has an interface for receiving a call from a calling device. The call includes a caller ID of the calling device. The PBX stores a company ID for identifying the company and includes a signal handler for forwarding the received call as a forwarded call to a receiving device, and a caller ID enhancer for adding context to the forwarded call. The context includes the company ID and a selection made by a user of the calling device. The receiving device displays the context prior to answering the forwarded call.

### RELATED APPLICATIONS

This application is a continuation-in-part of pending U.S. patent application Ser. No. 14/498,338, filed Sep. 26, 2014, and which is incorporated by reference herewith in its entirety.

### BACKGROUND

FIG. 1 shows a prior art call forwarding scenario 100 where a caller “A” calls company “B”, and is forwarded by a private branch exchange (PBX) 102 associated with company “B” to a call recipient “C”. Call recipient “C” receives caller ID information 104 indicating that caller “a” has initiated the call. However, call recipient “C” is not aware that the call has been forwarded from PBX 102 of company “B”.

### SUMMARY OF THE INVENTION

In one embodiment, a method for providing context to a forwarded call includes the steps of: receiving, within a private branch exchange (PBX) of a company, an incoming call from a calling device, the incoming call including a caller ID of the calling device; forwarding the incoming call to a receiving device; and adding context information to at least one field of a protocol of the forwarded call. The receiving device receives the context information prior to answering the forwarded call.

In another embodiment, a method provides context to a forwarded call. A PBX of a company receives an incoming call from a calling device, the incoming call including a caller ID of the calling device. The incoming call is forwarded to a receiving device. A USSD message containing a context of the forwarded call is generated and sent to the receiving device prior to a second ring of the forwarded call. The receiving device receives the context for the forwarded call.

In another embodiment, a system for providing context to a forwarded call includes a PBX associated with a company. The PBX includes an interface for receiving a call from a calling device, where the call includes a caller ID of the calling device. The interface determines an indication representing a selection made by a user of the calling device. The PBX includes a company ID for identifying the company, a signal handler for forwarding the received call as a forwarded call to a receiving device, and a caller ID enhancer for adding context to the forwarded call such that the receiving device displays the context of the forwarded call prior to answering the forwarded call. The context includes the caller ID and the indication.

### BRIEF DESCRIPTION OF THE FIGURES

FIG. 1 shows a prior art call forwarding scenario.

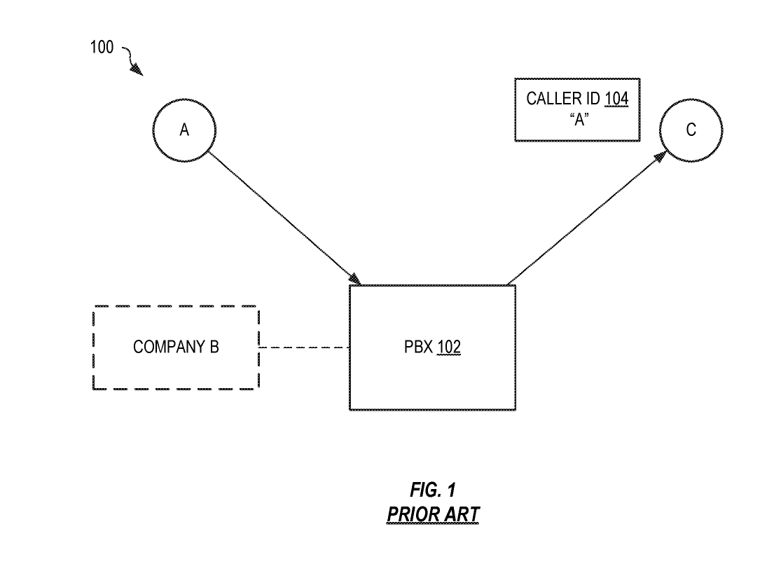

FIG. 2 shows one exemplary system for providing context to a forwarded call, in an embodiment.

FIG. 3 shows the directory of FIG. 2 in further exemplary detail.

FIG. 4 is a flowchart illustrating one exemplary method for providing context to a forwarded call, in an embodiment.

FIG. 5 shows one exemplary system for providing context to a forwarded call, in an embodiment.

FIG. 6 shows one exemplary system for providing context to a forwarded call, in an embodiment.

### DETAILED DESCRIPTION OF THE EMBODIMENTS

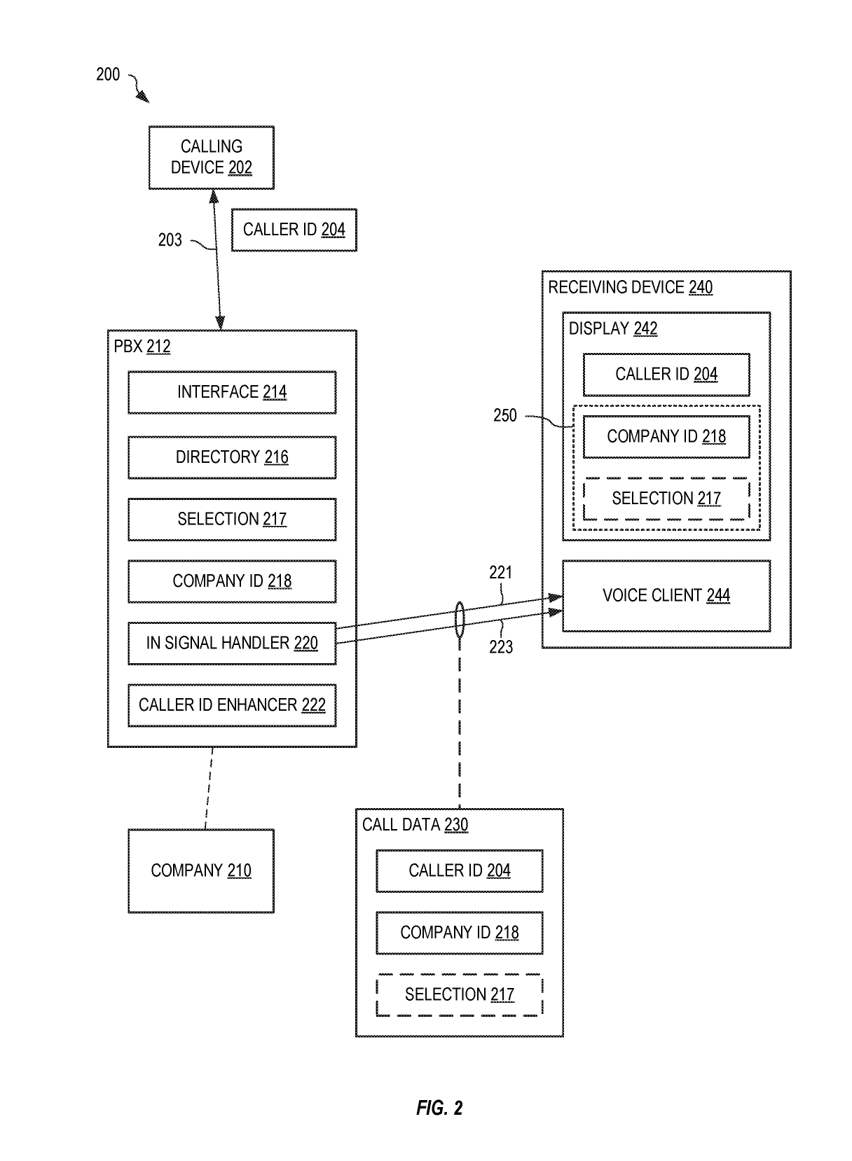

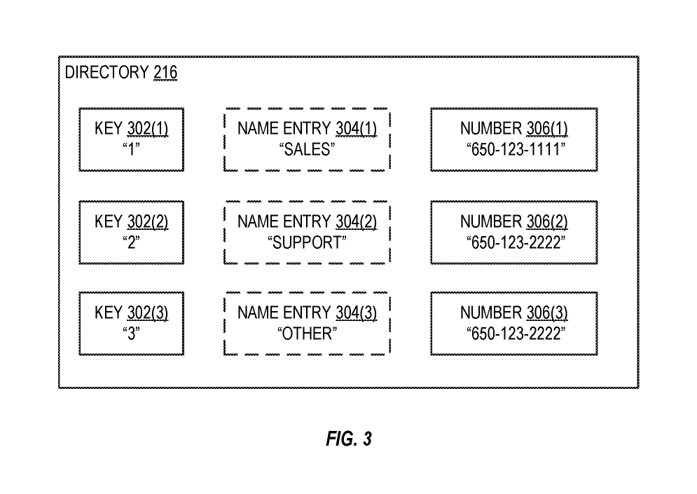

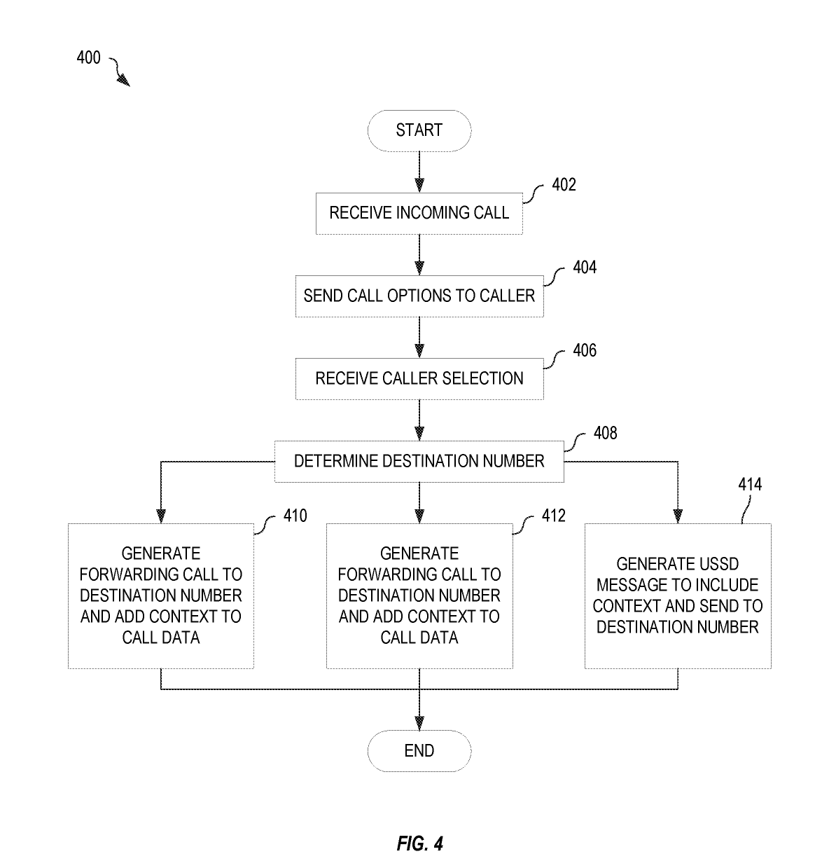

FIG. 2 shows one exemplary system 200 for providing context to a forwarded call, in an embodiment. A company 210 utilizes a private branch exchange (PBX) 212 to receive calls. PBX 212 may be located at or proximate company 210, but may be hosted elsewhere, such as in the cloud, at a carrier neutral data center, or at a carrier data center. PBX 212 includes an interface 214 and a directory 216. FIG. 3 shows directory 216 of FIG. 2 in further exemplary detail. FIG. 4 is a flowchart illustrating one exemplary method 400 for providing context to a forwarded call. Method 400 is for example implemented within PBX 212. FIGS. 2, 3, and 4 are best viewed together with the following description.

In one example of operation, as shown in step 402 of method 400, interface 214 answers a call from a calling device 202. As shown in step 402, interface 214 then audibly presents menu options from directory 216 to the user of calling device 202. For example, based upon directory 216, interface 214 may say “Press one for sales, press two for support, or press three for all other enquiries.” In step 406 of method 400, interface 214 receives a selection 217 from the user of calling device 202. In step 408, interface 214 determines a destination phone number (e.g., an external phone number corresponding to the selected entry within directory 216). For example, if the user of calling device 202 presses the “2” button to request to speak with someone from the support department of company 210, interface 214 retrieves number 306(2) “650-123-2222” from the second entry of directory 216. Interface 214 then triggers IN signal handler 220 of PBX 212 to forward incoming call 203 to receiving device 240 as forwarded call 221. Forwarded call 221 may be performed over a standard telephony signal such as a landline, and/or cellular network communication. In step 410 of method 400, IN signal handler 220 generates call data 230 for forwarded call 221 with caller ID 204 of calling device 202, a caller ID enhancer 222 adds company ID 218 of company 210 to one or more fields of call data 230, and the caller ID enhancer 222 optionally also adds selection 217 to one or more fields of call data 230. Company ID 218 may represent one or both of a telephone number of company 210, and a name of company 210. It should be appreciated that company ID 218 may not represent a company per se, but also an entity such as a person. In embodiments, call data 230 represents at least part of the IN signaling protocol of forwarded call 221. In embodiments, call data 230 may be transmitted via a separate connection other than forwarded call 221. For example, if a data network connection 223 (e.g. WiFi, BlueTooth, Cellular data, etc.) is available between PBX 212 and receiving device 240, then call data 230 may be transmitted thereon, while the call itself is transmitted as forwarded call 221.

Thus, upon receiving forwarded call 221, a voice client 244 of receiving device 240 may display caller ID 204, company ID 218, and optionally selection 217, on display 242 of receiving device 240 such that a user of receiving device 240 may fully understand the context of the incoming call prior to answering. That is, the information provided within company ID 218 and selection 217 forms additional context 250 for forwarded call 221.

For clarity of illustration, these examples do not show the switches used to handle calls 203, 211. As appreciated by one skilled in the art, calling device 202 may initiate call 203 via a first switch, and PBX 212 may initiate forwarded call 221 via the first switch, or via a second switch.

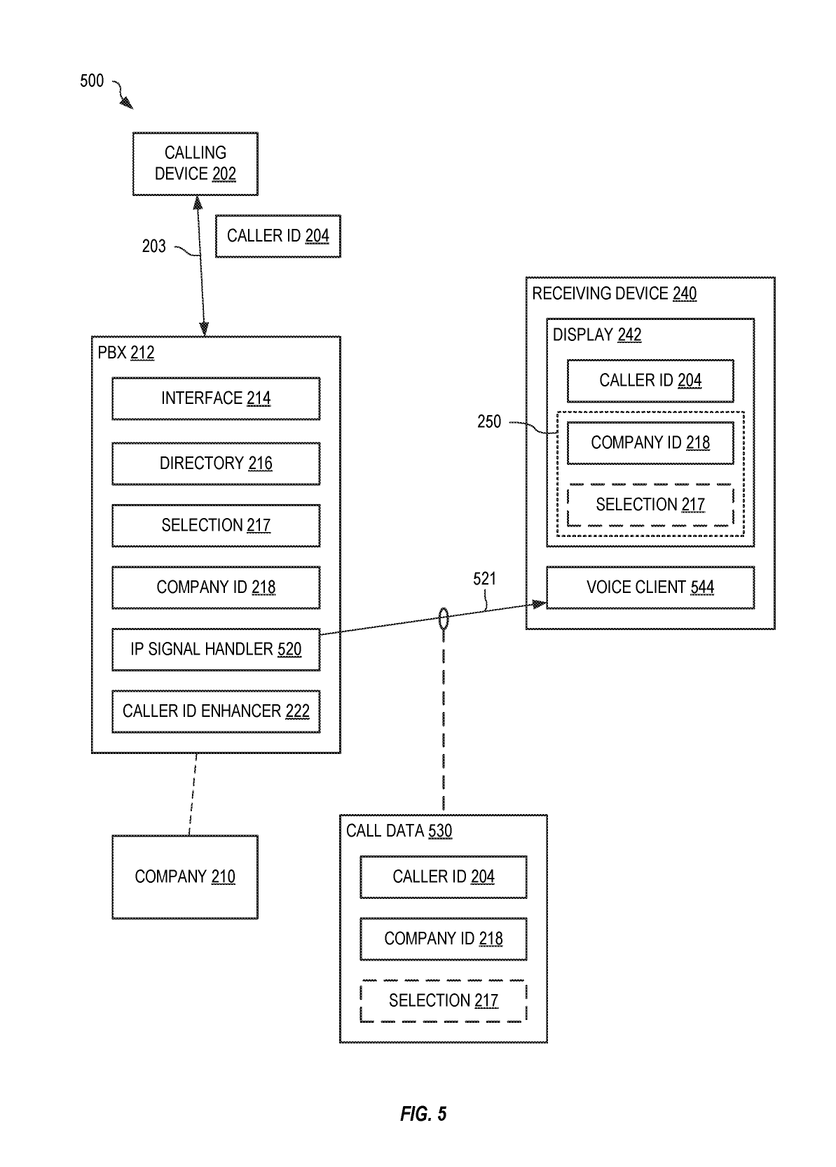

FIG. 5 shows one exemplary system 500 for providing context to a forwarded call, in an embodiment. System 500 is similar to system 200 of FIG. 2, but is configured to handle IP protocol calls. PBX 212 is configured with an IP signal handler 520 that operates to forward incoming call 203 to a voice client 544 of receiving device 240 as forwarded call 521. In step 412 of method 400, IP signal handler 520 generates call data 530 for forwarded call 521 with caller ID 204 of calling device 202, and caller ID enhancer 222 adds context of company ID 218 of company 210 to one or more fields of call data 530, and caller ID enhancer 222 optionally also adds context of selection 217 to one or more fields of call data 530. Call data 530 represents at least part of the IP signaling protocol of forwarded call 521, such as for one or more of SIP, XMPP and IAX signaling. In one embodiment, voice client 544 is modified to retrieve company ID 218, and optional selection 217 from the used fields of call data 530 and to then display additional context 250 as one or both of company ID 218, and optional selection 217 on display 242. In embodiments, compared to those discussed above where call data 230 is transmitted on a separate data network connection 230, in the embodiments of FIG. 5, call data 530 may be transmitted via the same IP signaling protocol as the forwarded call 521.

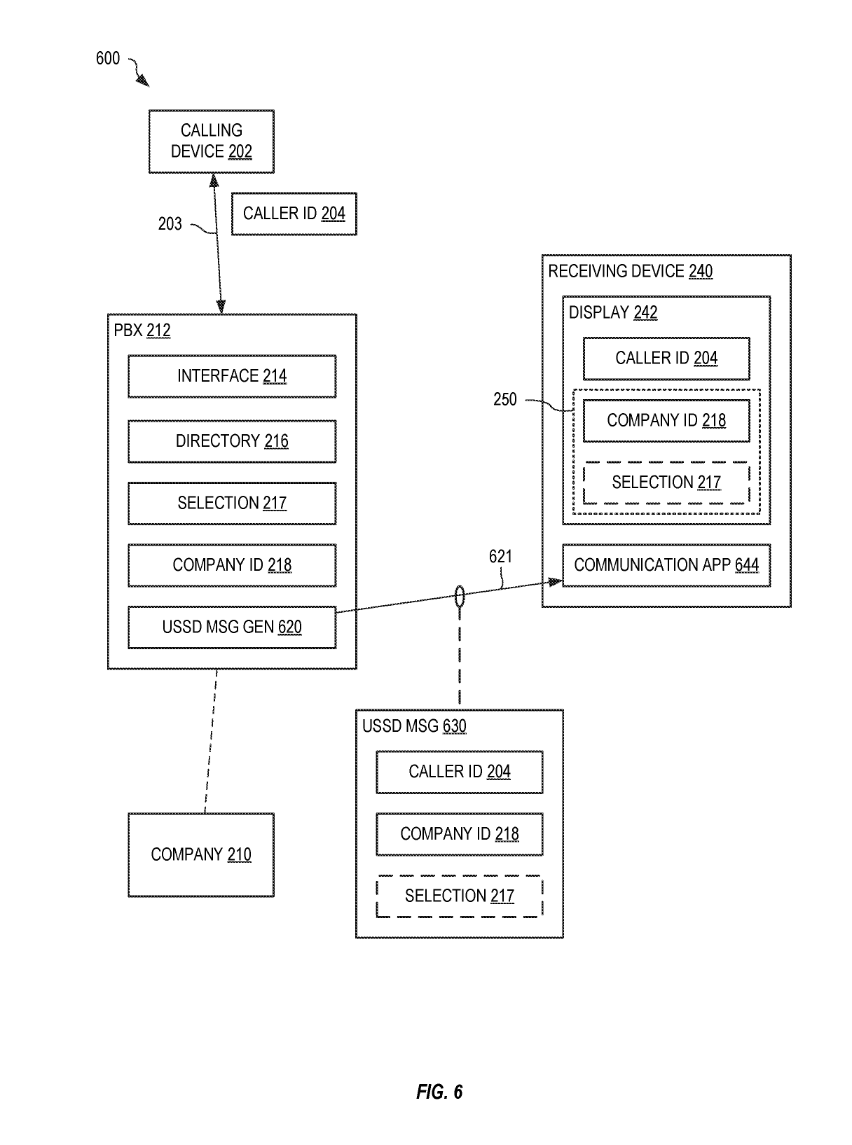

FIG. 6 shows one exemplary system 600 for providing context to a forwarded call, in an embodiment. System 600 is similar to system 200 of FIG. 2, but is configured to generate and send USSD (Unstructured Supplementary Service Data) messages to communication application 644 of receiving device 240 immediately prior to initiating forwarding incoming call 203 to receiving device 240 (or prior to the second ring of forwarded incoming call 203). Communication application 644 may be an application downloaded to the receiving device, built into the operating system of the receiving device, or configured as other software components. As such, communications application may include computer readable instructions stored within memory that when executed by a processer enable the functionality of communication application 644 discussed herein. communication application 644 In step 414 of method 400, USSD message generator 620 generates, prior to forwarding incoming call 203, USSD message 630 including caller ID 204 of calling device 202, company ID 218 of company 210, and optionally selection 217.

In one embodiment, PBX 212 includes two or more of IN signal handler 220, IP signal handler 520, and USSD message generator 620. Thus, PBX 212 may invoke optimal call handling based upon one or both of incoming call 203 and receiving device 240. For example, directory 216 may define a configuration of each receiving device 240 in association with number 306, such that forwarded call 221, 521 and USSD message 621 is automatically used. USSD message 621 may be another messaging data service such as SMS, etc.

In one embodiment, voice client 544 and/or communication application 644 is configured to change a color attribute (e.g., a skin, a background color, and/or a font color) of display 242 based upon one or both of received company ID 218 and selection 217 to provide additional context 250. Thus, the user of receiving device 240 is clearly informed of the company associated with the incoming call and context thereof.

Call data 230, 530 may be presented on receiving device 240 in a variety of ways. For example, call data 230, including one or more of caller ID 204, company ID 218 and selection 217, may be presented in a table format, via color coded information (i.e. blue color for a given company, red for another given company), or via a “tree” indicating the call path (i.e. incoming call from caller ID 204 to company 218, to receiving device 240 via selection 217).

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for providing context to a forwarded call, comprising:
receiving, within a private branch exchange (PBX) of a company, an incoming call from a calling device, the incoming call including a caller ID of the calling device;
forwarding the incoming call and context information to a receiving device external to the company, the context information including the caller ID and a company ID of the company.

2. The method of claim 1, the context information further including a selection made by a user of the calling device when interacting with the PBX.

3. The method of claim 1, the company ID being a name of the company.

4. The method of claim 1, the company ID being a name of a person.

5. The method of claim 1, the context information being forwarded in relation to the incoming call such that the context information is displayable on the receiving device prior to answering the incoming call by the receiving device.

6. The method of claim 1, the incoming call being forwarded based on a telephony network connection, and the context information being forwarded based on a data network connection.

7. The method of claim 1, the context information being based on a color code.

8. The method of claim 1, the context information being based on a tree indicating the call path of the incoming call.

9. The method of claim 1, the context information being in table format.

10. The method of claim 1, the step of receiving including receiving the incoming call as an IP protocol.

11. The method of claim 10, the step of forwarding including forwarding the incoming call and the context information on a single IP signaling protocol connection between the PBX and the receiving device.

12. A system for providing context to a forwarded call, comprising:
a PBX within a company, the PBX comprising:
an interface for receiving a call from a calling device, the call comprising a caller ID of the calling device, and the interface determining an indication representing a selection made by a user of the calling device;
a company ID for identifying the company;
a signal handler adapted to forward the received call as a forwarded call to a receiving device external to the company; and
a caller ID enhancer for generating context about the forwarded call for display at the receiving device, the context including the caller ID and the company ID.

13. The system of claim 12, the company ID being a name of the company.

14. The system of claim 12, the company ID being a name of a person.

15. The system of claim 12, the signal handler adapted to forward the forwarded call on a first connection between the PBX and the receiving device, and the context information on a second connection between the PBX and the receiving device.

16. The system of claim 15, the second connection being a data network connection.

17. The system of claim 12, the context information being based on a color code.

18. The system of claim 12, the context information being based on a tree indicating the call path of the incoming call.

19. The system of claim 12, the context information being in table format.
